(19) United States
(12) Patent Application Publication
(10) Pub. No.: US 2012/0282408 A1
(43) Pub. Date: Nov. 8, 2012

(54) SOL-GEL COATING FOR STEEL AND CAST IRON SUBSTRATES AND METHODS OF MAKING AND USING SAME

(76) Inventors: John Jacob, Franklin, TN (US); Steve Pew, Kingston Springs, TN (US); Hemant Dandekar, Nashville, TN (US)

(21) Appl. No.: 13/508,804

(22) PCT Filed: Nov. 10, 2010
(86) PCT No.: PCT/US2010/056191

§ 371 Date: Jul. 31, 2012

Related U.S. Application Data
(63) Continuation of application No. 12/615,487, filed on Nov. 10, 2009.

(51) Int. Cl. B05D 3/02; B05D 1/36

(52) U.S. Cl. 427/397.7; 427/402

(57) ABSTRACT

Methods and compositions for providing a durable, non-stick coating on steel and/or cast iron surfaces are disclosed. Disclosed is a method for coating a steel or cast iron substrate, the method comprising contacting at least a portion of a steel or cast iron substrate with a porcelain enamel coating formulation to form a first coating, roughening at least a portion of the first coating, and then contacting that portion of first coating with a sol-gel composition. An article is also disclosed comprising a steel or cast iron substrate, a porcelain enamel coating attached to the substrate, wherein a portion of a surface of the porcelain enamel coating opposite the substrate is roughened, and a non-stick coating attached to the roughened porcelain enamel coating.

### BACKGROUND

### Technical Field

The present disclosure relates to steel and cast iron articles and methods for applying coatings thereto.

### Technical Background

Cast iron has been used for cookware since at least the early 1700's. The original popularity of cast iron cookware resulted from its ease of manufacture. Since that time many developments have been made in materials and cookware, yet cast iron cookware remains popular. The superior heat retention and diffusion properties of cast iron, along with its health benefits and ability to withstand high temperatures without damage, result in it being highly desirable. If properly seasoned and maintained, cast iron cookware can provide a relatively non-stick cooking surface.

While traditional cast iron cookware can provide a superior cooking experience, it requires specialized care and maintenance. For example, traditional cast iron cookware must be seasoned by coating with oil and heating to form magnetite layer of black iron oxide on its surface. After seasoning, a thin layer of oil must be maintained on the surface to impart a hydrophobic surface and thus prevent water contact with the underlying metal. Seasoned cast iron cookware can be wiped clean after use, but should not be placed in a dishwasher or contacted with detergents. If not well maintained, concerns about rust, rancid oil, bacteria growth, and carry-over flavors can render cast iron cookware unsuitable when compared to other modern alternatives.

In addition to seasoned cast iron, porcelain enamel coated cast iron cookware is popular. Porcelain enamel cast iron has a vitreous enamel glaze coated on the cast iron surface that can prevent rusting, eliminate the need to season, and impart dishwasher safe and scratch resistant properties unavailable with traditional cast iron. Unlike traditional seasoned cast iron, porcelain enamel coated cast iron does not provide a non-stick cooking surface.

Another option for cast iron cookware includes sol-gel coated cast iron. While non-stick, this cookware is typically rough and can corrode quickly if washed in a dishwasher.

As new materials have been developed, alternatives to cast iron have also gained popularity. Aluminum cookware can be anodized to provide an aluminum oxide surface that is non-stick, but concerns have been raised about potential links between aluminum and Alzheimers disease. Similarly, aluminum and stainless steel cookware can be coated with fluorinated polymers, such as for example, polytetrafluoroethylene (PTFE), to provide non-stick properties. While very non-stick, PTFE coated surfaces can be scratched easily and are not recommended for use in dishwashers. In recent years, concerns have been raised about the safety of food cooked in PTFE coated cookware. If heated above about 450° F., PTFE coatings can begin to decompose, releasing potentially harmful compounds into the surrounding environment. Small pieces of the PTFE coating can also become dislodged from the cookware surface, for example when scratched, and ingested with food.

Thus, there is a need to address the problems and other shortcomings associated with the non-stick cookware. These needs and other needs are satisfied by the compositions and methods of the present disclosure.

### SUMMARY

In accordance with the purpose(s) of the invention, as embodied and broadly described herein, this disclosure, in one aspect, relates to steel and cast iron articles and methods for applying coatings thereto.

In one aspect, the present disclosure provides a method for coating a steel or cast iron substrate, the method comprising contacting at least a portion of a steel or cast iron substrate with a porcelain enamel coating formulation to form a first coating, roughening at least a portion of the first coating, and then contacting that portion of first coating with a sol-gel composition.

In another aspect, the present disclosure provides an article produced by the method described above.

In another aspect, the present disclosure provides an article comprising a steel or cast iron substrate, a porcelain enamel coating attached to the substrate, wherein a portion of a surface of the porcelain enamel coating opposite the substrate is roughened, and a non-stick coating attached to the roughened porcelain enamel coating.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates a cast iron surface coated with a sol-gel layer over a roughened gloss black porcelain enamel coating.

FIG. 2 illustrates a cast iron surface coated with a sol-gel layer over an unroughened gloss black porcelain enamel coating.

FIG. 3 illustrates a cast iron surface coated with a sol-gel layer over a roughened matte black porcelain enamel coating.

FIG. 4 illustrates a cast iron surface coated with a sol-gel layer over an unroughened matte black porcelain enamel coating.

FIG. 5 illustrates a sol-gel coated cast iron substrate with no porcelain enamel coating, after washing in a dishwasher.

FIG. 6 illustrates a sol-gel coated cast iron substrate with porcelain enamel coating, after washing in a dishwasher.

FIG. 7 illustrates a sol-gel coated cast iron substrate with porcelain enamel coating, after scratching and then washing in a dishwasher.

FIG. 8 illustrates a non-stick coated steel burner bowl, prepared in accordance with the various aspects of the present disclosure.

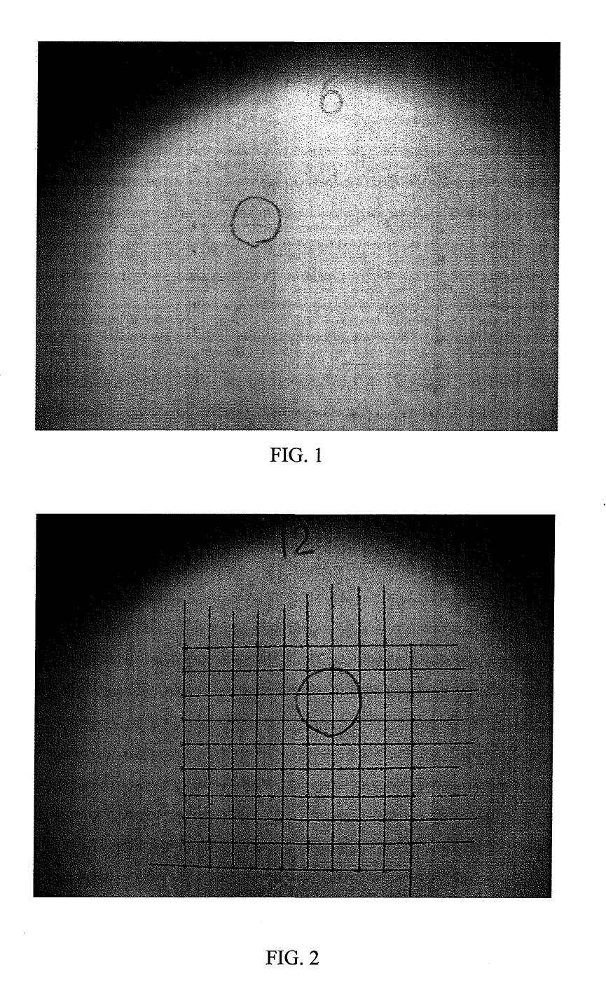

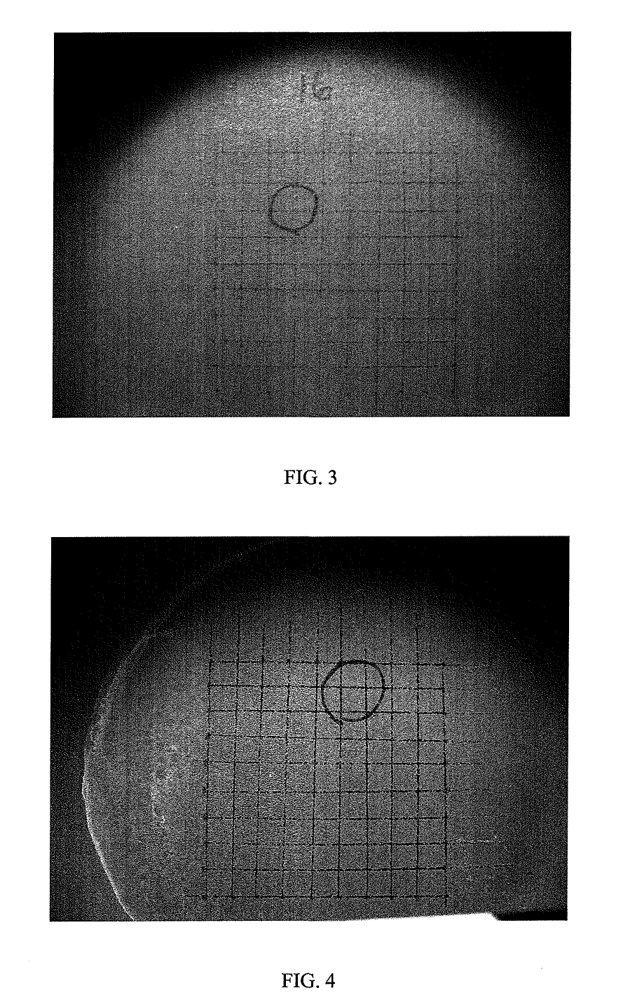

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular components unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

### DEFINITIONS

As used in the specification and the appended claims, the singular forms “a,” “an” and “the” include plural referents unless the context clearly dictates otherwise. Thus, for example, reference to “a coating” or “a sol-gel material” includes mixtures of two or more coatings or sol-gel materials.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

As used herein, the term “sol-gel” is intended to refer to a composition or method for forming a networked material from a starting solution. Some sol-gels can form, for example, ceramic materials upon deposition and heating. In various aspects, the final network can be a network of discrete particles or a polymer network. Exemplary precursors can, in various aspects, comprise metal oxides, metal alkoxides, metal salts, and/or other compounds and combinations thereof.

As used herein, the term “non-stick” is intended to refer to the ability to remove food or cooking products from the surface. Non-stick is intended to mean that all or substantially all food or cooking products can be easily removed without adhering to the cookware surface, but does not necessarily mean that no portion of a food or cooking product will adhere.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly discussed above, the present disclosure provides compositions and methods for preparing durable, wear-resistant, non-stick coatings for steel and/or cast iron materials. In one aspect, the methods of the present invention comprise applying a two layer coating to a steel and/or cast iron substrate. In other aspects, the methods of the present invention comprise applying a porcelain enamel coating to a substrate, roughening the surface of the porcelain enamel coating, and subsequently applying a sol-gel coating can impart non-stick properties to the coated surface.

The various methods and compositions of the present disclosure can provide a durable, non-stick coating for steel and cast iron surfaces. Many traditional coatings, such as porcelain enamels, are durable, but do not provide a non-stick surface. Other coatings can provide a non-stick coating, but are easily damaged, exposing the underlying substrate and allowing corrosion. The methods and compositions described herein relate to a multistep coating process comprising, in one aspect, a two layer coating and an intermediate treatment step. The resulting coatings and coated articles can be both durable and non-stick.

### Substrate

The substrate of the present invention can comprise any steel and/or cast iron material suitable for use in the various methods described herein. In one aspect, the substrate can comprise an article of cookware or a precursor thereto. In another aspect, the substrate can comprise a grill, a grill grate, a griddle, an appliance part, or a combination thereof. In still other aspects, the substrate can comprise a cast iron material suitable for other applications in which a durable, non-stick coating is desirable, and the present invention is not intended to be limited to any particular substrate or application.

In one aspect, the substrate of the present invention can comprise any iron or steel appropriate for coating with the materials described herein. In various aspects, the substrate can comprise a steel, gray cast iron, white cast iron, ductile cast iron, malleable cast iron, chilled cast iron, mottled cast iron, compacted cast iron, high-alloy cast iron, or a combination thereof. In a specific aspect, the substrate comprises steel, such as, for example, a low carbon enameling steel (ASTM A424-Type I). In another specific aspect, the substrate comprises gray cast iron. In another aspect, the substrate of the present invention is at least one of the following: machineable, castable, capable of being coated with an enamel, has characteristics imparted from a graphite structure, and/or a combination thereof. In yet another aspect, the substrate of the present invention is machineable, castable, capable of being coated with an enamel, and has characteristics imparted from a graphite structure.

In one aspect, the substrate of the present invention can comprise any chemical composition or ally suitable for use in the methods recited herein. In another aspect, the substrate or a portion thereof has a total carbon content of from about 2.6 wt. % to about 4 wt. %, for example, about 2.6, 2.8, 3.0, 3.2, 3.4, 3.6, 3.8, or 4 wt. %; or from about 3.25 wt. % to about 3.6 wt. %, for example, about 3.25, 3.3, 3.35, 3.4, 3.45, 3.5, 3.55, or 3.6 wt. %. In another aspect, the substrate or a portion thereof has a graphitic carbon content of from about 2.4 wt. % to about 3.5 wt. %, for example, about 2.4, 2.6, 2.8, 3.0, 3.1, 3.3, or 3.5 wt. %; or from about 2.8 wt. % to about 3.2 wt. %, for example, about 2.8, 2.9, 3.0, 3.1, or 3.2 wt. %. In yet another aspect, the substrate or a portion thereof comprises a combined carbon content of from about 0.20 wt. % to about 0.52 wt. %, for example, about 0.20, 0.22, 0.24, 0.26, 0.28, 0.30, 0.32, 0.34, 0.36, 0.38, 0.40, 0.42, 0.44, 0.46, 0.50, or 0.52 wt. %. In yet another aspect, the substrate or a portion thereof comprises a silicon content of from about 2.1 wt. % to about 3.5 wt. %, for example, about 2.1, 2.3, 2.5, 2.7, 2.9, 3.1, 3.3, or 3.5 wt. %, or from about 2.25 to about 3 wt. %, for example, about 2.25, 2.5, 2.75, or 3 wt. %. In still another aspect, the substrate or a portion thereof comprises a manganese content of from about 0.2 wt. % to about 1 wt. %, for example, about 0.2, 0.3, 0.4, 0.5, 0.6, 0.7, 0.8, 0.9, or 1 wt. %; or from about 0.45 wt. % to about 0.65 wt. %, for example, about 0.45, 0.5, 0.55, 0.6, 0.65 wt. %. In still another aspect, the substrate or a portion thereof comprises a phosphorous content of from about 0.1 wt. % to about 1.2 wt. %, for example, about 0.1, 0.2, 0.3, 0.4, 0.5, 0.6, 0.7, 0.8, 0.9, 1.0, 1.1, or 1.2 wt. %, or from about 0.6 wt. % to about 0.95 wt. %, for example, about 0.6, 0.65, 0.7, 0.75, 0.8, 0.85, 0.9, or 0.95 wt. %. In still another aspect, the substrate of a portion thereof optionally comprises a sulfur content of up to about 0.04 wt. % for example, about 0, 0.01, 0.02, 0.03, or 0.04 wt. %. In yet another aspect, the substrate comprises, if at all, less than about 0.09 wt. % sulfur.

In still other aspects, the substrate of the present invention can have total carbon, graphitic carbon, combined carbon, silicon, manganese, phosphorous, and/or sulfur levels lower than or greater than the values recited here, and the present invention is not intended to be limited to any particular range of such a component. In still other aspects, the substrate of the present invention can comprise additional elements not recited herein. In still further aspects, the substrate of a portion thereof can comprise one or more additional metals or alloys thereof.

In still further aspects, the substrate of the present invention or a portion thereof can comprise any iron phase suitable for use in the methods recited herein. Similarly, the microstructure of a substrate can vary, depending upon such factors as the chemical composition and heat history of the material, and the present invention is not intended to be limited to any particular iron phase or microstructure. In a specific aspect, the microstructure of a substrate comprises a well distributed fine to medium flake graphite dispersed in a matrix of ferrite or a ferrite-pearlite mix.

The substrate of the present invention can also comprise any suitable geometry, physical form, and thickness. In one aspect, the geometry, physical form, and thickness of a substrate is dependent upon the intended application, such as, for example, a skillet. The thickness of a substrate can also be dependent upon, for example, the heat retention and diffusion characteristics that are desired.

### Porcelain Enamel

The porcelain enamel coating of the present invention can comprise any porcelain enamel coating capable of application to a substrate. In one aspect, the porcelain enamel coating comprises a three part enamel formulation comprising a flux frit, a matting frit, and a bulking frit. In another aspect, an enamel formulation can comprise optional additional components, such as, for example, clays, electrolytes, and pigments to impart specific properties to an enamel formulation. In one aspect, such optional additional components can be used to adjust and/or control the rheology and color of an enamel formulation. Porcelain enamel coating formulations, including any optional additional components are commercially available, and one of skill in the art, in possession of this disclosure, could readily select an appropriate porcelain enamel coating formulation for a specific application. Exemplary porcelain enamel coating formulations are available from Pemco International and Ferro Corporation. The components and concentrations of an exemplary enamel coating formulation are detailed in Tables 1 and 2, below. It should be noted that the specific components and concentrations of any individual porcelain enamel coating formulation can vary depending upon, for example, the substrate material.

TABLE 1
Exemplary Porcelain Enamel Coating Formulation for Cast Iron

| Function | Material | Concentration (wt. %) |
|---|---|---|
| Matting | Ferro XF131 | 3.6 |
| Bonding Glass | Ferro XG-376-4 | 64.3 |
| Filler | Ferro XG-982 | 7.1 |
| Suspension Agent | #55 Clay | 3.6 |
| Extender | Silica | 17.9 |
| Suspension Agent | Bentonite | 0.2 |
| Flocculant | Borax | 0.2 |
| Flocculant | Magnesium Carbonate | 0.1 |
| Flocculant | Sodium Nitrite | 0.2 |
| Deflocculant | S-1182 | <0.1 |
| Pigment | 927 | 2.9 |

TABLE 2
Exemplary Porcelain Enamel Coating Formulation for Low Carbon Steel

| Material | Concentration (wt. %) |
|---|---|
| Ferro XG 372 | 31.3 |
| Ferro XG-689 | 17.9 |
| Ferro XG-657 | 40.2 |
| #55 Clay | 4.5 |
| Silica | 2.7 |
| Bentonite | 0.2 |
| Magnesium Carbonate | 0.1 |
| Sodium Nitrite | 0.1 |
| Black Oxide Pigment | 2.7 |
| Brown Oxide Pigment | 0.4 |

In one aspect, the porcelain enamel coating formulation can comprise a paste. In another aspect, the porcelain enamel coating formulation can comprise a liquid. In another aspect, the porcelain enamel coating formulation can be contacted with at least a portion of the substrate so as to provide a uniform or substantially uniform coating.

The manner in which the porcelain enamel coating formulation is contacted with the substrate can vary, depending upon, for example, the physical form of the porcelain enamel coating formulation and the desired thickness of the resulting coating. In one aspect, a wet porcelain enamel coating formulation can be spray coated onto at least a portion of a substrate. In other aspects, the porcelain enamel coating formulation can be thermal sprayed or coated using a doctor blade technique. In still other aspects, the porcelain enamel coating formulation can be contacted and/or deposited via an electrophoretic technique.

In various aspects, the thickness of a porcelain enamel coating can be from about 75 micrometers to about 275 micrometers, for example, about 75, 125, 175, 225, or 275 micrometers; or from about 75 to about 175 micrometers, for example, about 75, 100, 125, 175 micrometers. In other aspects, the thickness of a porcelain enamel coating or a portion thereof can be less than about 75 micrometers or greater than about 275 micrometers, and the present invention is not intended to be limited to any particular thickness.

In one aspect, a porcelain enamel coating provides a coating that covers at least a portion of a substrate. In one aspect, the porcelain enamel coating is free of or substantially free of defects, such as, for example, pinhole defects wherein water could permeate the defect and contact the substrate. In another aspect, the porcelain enamel coating is durable and capable of withstanding high temperatures. In another aspect, the porcelain enamel coating is capable is withstanding the stresses associated with handling, storage, and use of typical cookware. In yet another aspect, the porcelain enamel coating is well bonded or adhered to the substrate and can resist chipping, flaking, spalling, or delaminating from the substrate surface.

In one aspect, a porcelain enamel coated cast iron substrate can be heated to fire the porcelain enamel coating. The specific method, temperature, and duration of heating can vary, depending upon the specific coating formulation, the thickness thereof, thermal mass, and geometric configuration of the coated substrate. In a specific aspect, a porcelain enamel coated substrate can be heated in, for example, a continuous gas furnace for a time and at a temperature sufficient to fire the porcelain ceramic coating. In another aspect, a coated substrate is heated to a temperature of at least about 648° C., for example, about 648, 700, 730, 745, 755° C. or higher. In another aspect, a coated substrate is heated to a temperature of from about 648° C. to about 760° C., for example, about 648, 665, 670, 685, 700, 715, 730, 745, or 760° C.; or from about 730° C. to about 755° C., for example, about 730, 735, 740, 750, or 755° C.

In a specific aspect, a coated cast iron substrate is heated to a temperature of at least about 755° C. In still another aspect, a coated substrate is heated for a period of time, for example, at least about 5 min, so as to fire the porcelain ceramic coating. In various aspects, the coated substrate is heated for at least about 5 min, at least about 8 min, at least about 12 min, at least about 15 min, at least about 18 min, or more. In a specific aspect, a coated substrate is heated to a temperature of at least about 732° C. for a period of time from about 12 to about 20 minutes.

In one aspect, a porcelain enamel coated steel substrate can be heated to fire the porcelain enamel coating. The specific method, temperature, and duration of heating can vary, depending upon the specific coating formulation, the thickness thereof, thermal mass, and geometric configuration of the coated substrate. In a specific aspect, a porcelain enamel coated substrate can be heated in, for example, a continuous gas furnace for a time and at a temperature sufficient to fire the porcelain ceramic coating. In another aspect, a coated substrate is heated to a temperature of at least about 800° C., for example, about 800, 815, 825 or 850° C. or higher. In another aspect, a coated substrate is heated to a temperature of from about 800° C. to about 850° C., for example, about 800, 810, 820, 830, 840, 850° C.; or from about 800° C. to about 825° C., for example, about 800, 805, 810, 815, or 825° C.

In a specific aspect, a coated steel substrate is heated to a temperature of at least about 825° C. In still another aspect, a coated substrate is heated for a period of time, for example, at least about 2 min, so as to fire the porcelain ceramic coating. In various aspects, the coated substrate is heated for at least about 1 min, at least about 2 min, at least about 4 min, at least about 15 min, at least about 18 min, or more. In a specific aspect, a coated substrate is heated to a temperature of at least about 825° C.

The porcelain enamel coating can comprise one or multiple, for example, 2, 3, 4 or more, individual layers of porcelain enamel. In one aspect, the porcelain enamel coating comprises a single layer. In another aspect, the porcelain enamel coating comprises at least two layers. In one aspect, a porcelain enamel coating comprising multiple layers can exhibit improved asthetic properties, improved isolation of the underlying metal substrate, or a combination thereof. It should be understood that any individual coating layer can comprise the same or a different composition than any other coating layer. In one aspect, at least two layers are present and comprise the same or similar composition. In another aspect, at least two layers are present, and at least one layer comprises a composition different from at least one other layer. Such a variation in composition can, in various aspects, provided desired gloss and chemical resistance characteristics. Similarly, the thickness, method of contacting, and method of firing, can be the same or different for any individual porcelain enamel coating layer. In one aspect, if two or more layers are present, any individual layer other than the first, can be contacted directly to a wet underlying layer, wherein the layers are subsequently fired together. In another aspect, if two or more layers are present, any individual layer can applied and fired prior to the application of a subsequent layer.

### Surface Treatment

After firing, the porcelain enamel coating can, in various aspects, have a smooth finish. To improve bonding and adhesion of subsequent layers, the exterior surface of the porcelain enamel coating, for example, the surface opposite that of the substrate, is subjected to a treatment step. Such a treatment step can roughen the surface of the porcelain enamel coating. While not wishing to be bound by theory, a surface treatment as described herein can increase the surface microstructure, enabling an interaction, such as, for example, a locking interaction between layers. In a specific aspect, the surface treatment can comprise roughening via a sand blasting technique. In one aspect, the surface topography of a roughened porcelain enamel layer can be from about 1.3 micrometers to about 3.2 micrometers, for example, about 1.3, 1.5, 1.7, 1.9, 2.1, 2.2, 2.4, 2.6, 2.8, 3.0, or 3.2 micrometers, or from about 2.0 micrometers to about 2.5 micrometers, for example, about 2.0, 2.1, 2.2, 2.3, 2.4, or 2.5 micrometers. In such a technique, the fired porcelain enamel coating can be subjected to, for example, a 60-180 grit material, or an 80-120 grit material. The grit material can be any material suitable for roughening the surface of a coated substrate, and in various aspects, can comprise aluminum oxide, silicon carbide, olivine, or a combination thereof. In one aspect, the grit material is blasted on the surface of the porcelain enamel coating at pressures ranging from about 3-7 bar or from about 4 to 5.1 bar. In other aspects, various techniques can be utilized to roughen the surface of the porcelain enamel coating, and the present disclosure is not intended to be limited to any particular surface treatment technique.

In other aspects, an enamel coating formulation or method for applying the same can be selected so as to provide a porcelain enamel coating having a desired surface roughness, as described herein. In one aspect, a porcelain enamel coating can have a desired surface roughness and a separate roughening step is not required or performed. In another aspect, a porcelain enamel coating can have a surface roughness at least partially sufficient to bond and/or adhere to a subsequently applied sol-gel layer. In such an aspect, a separate surface roughening step can be optional, and, if performed, can be shorter in duration and/or intensity.

### Sol-Gel Layer

After treatment of the fired porcelain enamel coating, a second coating can be applied to the treated surface. The second coating can comprise a sol-gel material that can provide a non-stick surface. The specific chemical composition of the second coating can vary, provided that it can bond and/or adhere to the roughened porcelain enamel coating without delaminating, spalling, cracking, and/or flaking, and that it can provide a non-stick surface.

In one aspect, the second coating comprises a mineral based material, such as, for example, a ceramic material, that can provide a non-stick surface. In one aspect, the second coating comprises a silane containing material. In another aspect, the second coating comprises a substituted silane, such as, for example, a methyl triethoxy silane. In such an aspect, a starting silane material such as tetramethoxy silane or tetraethoxy silane can be contacted with an additive or reactant to provide the substituted silane. In one aspect, the substitution group can comprise an alkyl group and/or a fluorine containing group. In one aspect, the substitution group can comprise from about 1 to about 3 carbon atoms, for example, a methyl, ethyl, or propyl group. In another aspect, the substitution group can comprise a fluorine containing group.

In yet another aspect, a hydrolysis product of the second coating material comprises an alcohol, such as, for example, isopropyl alcohol. In various specific aspects, the second coating comprises a tri-methyl-propxy-silane, a fluor-alkyl propoxy silane, or a combination thereof. In one aspect, the second coating comprises a material that, upon contacting the roughened surface, can yield hydrophobic surface.

In other aspects, the second coating can comprise a commercially available sol-gel coating, such as, for example, THERMOLON® EXPERT, ENDURANCE and ROCKS manufactured by Thermolon Ltd., or PURESTONE PCC 201, manufactured by Y&B Co, Ltd.

In one aspect, the second coating material can comprise additional optional components such as, for example, fillers, pigments, and/or other metals. In yet another aspect, the second coating material can be selected such that the resulting coating has a coefficient of thermal expansion similar to or substantially similar to that of the porcelain enamel coating.

In one aspect, the porcelain enamel coated substrate is heated to, for example, about 20-60° C. prior to contacting with the second coating material. In a specific aspect, the porcelain enamel coated substrate is heated to about 25-35° C. prior to contacting with the second coating material.

Once heated, the second coating material can be contacted with the roughened porcelain enamel coated substrate in any manner suitable for use in providing a non-stick surface. In various aspects, the second coating material can be sprayed, spread, or dip-coated on the roughened porcelain enamel coated surface.

In one aspect, the second coating material is contacted so as to provide a dry film thickness of from about 8 to about 70 micrometers, for example, about 8, 12, 16, 20, 24, 28, 32, 36, 40, 44, 48, 52, 56, 60, 64, 68, or 70 micrometers; or from about 25 to about 45 micrometers, for example, about 25, 27, 29, 31, 33, 35, 37, 39, 41, 43, or 45 micrometers.

After contacting the porcelain enamel coated cast iron substrate with the second coating material, the coated cast iron substrate can be heated at a time and temperature, for example, to remove all or at least a portion of any volatile components in the second coating material or a reaction byproduct therefrom. In one aspect, the substrate can be heated by placing in an ambient oven or an oven initially held at about 30° C. and then ramped to a temperature of from about 280° C. to about 320° C. over a period of from about 6 to about 15 minutes, such as, for example, about 6, 7, 8, 9, 10, 11, 12, 13, 14, or 15 minutes. In such an aspect, the substrate can then be held at that temperature for a period of time of at least about 7-10 minutes, for example, at least about 7 minutes, at least about 8 minutes, at least about 9 minutes, or at least about 10 minutes. In another aspect, the heating ramp can be from about 12° C./min to about 45° C./min, for example, about 12, 14, 16, 18, 20, 22, 24, 26, 28, 30, 32, 34, 36, 38, 40, 42, 44, or 45° C./min; from about 12° C./min to about 36° C./min, for example, about 12, 14, 16, 18, 20, 22, 24, 26, 28, 30, 32, 34, or 36° C./min; from about 14° C./min to about 36° C./min, for example, about 14, 16, 18, 20, 22, 24, 26, 28, 30, 32, 34, or 36° C./min; from about 20° C./min to about 40° C./min, for example, about 20, 22, 24, 26, 28, 30, 32, 34, 36, 38, or 40° C./min; or from about 21° C./min to about 29° C./min, for example, about 21, 22, 23, 24, 25, 26, 27, 28, or 29° C./min. Once heated and at least partially cured, the oven and/or the substrate can be cooled to ambient temperature.

The resulting non-stick coating comprises at least one of the following properties: heat resistant, scratch resistant, corrosion resistant, chemical resistant, high surface hardness, non-stick, and/or combinations thereof. In addition, the resulting coating can exhibit a smooth finish and a uniform gloss appearance. In one aspect, the coating system of the present disclosure is durable and can withstand the stresses and conditions of high temperature cookware and other applications. In another aspect, the coating can withstand temperatures as high as 425° C. and can withstand sustained exposure to temperatures in the range of 280° C. to 300° C. In another aspect, the non-stick properties of the resulting coating can be measured using the contact angle of a water droplet against the surface of the coating. In one aspect, the water contact angle can be from about 85 to about 105 degrees, or from about 90 to about 105 degrees.

It should be appreciated that the inventive methods and coating compositions recited herein can provide a durable, non-stick coating to steel and cast iron surfaces. Other methods and compositions known in the art can provide either: a non-stick coating that can easily damaged, exposing the underlying substrate to potential corrosion; or a durable porcelain enamel coating that does not exhibit non-stick properties. The multi-step approach of the current invention provides a durable, non-stick coating.

The multi-layer coating compositions of the present disclosure and substrates subjected to the methods described herein, can be useful in a variety of applications. In various aspects, such coated substrates can be useful in wire grills made of steel or cast iron, oven and range components, oven interior surfaces, oven racks, burner bowls, caps, burners, and steel and cast iron grates.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Effect of Porcelain Enamel Coating

In a first example, a series of cast iron substrates were first coated with porcelain enamel with composition similar to show in Table 1. The enameled substrate samples were then coated with sol-gel coatings. The substrate was preheated to a temperature of 40° C. The substrated was then sprayed with THERMOLON® EDURANCE. The substrates were heated to 115° C. and maintained at that temperature for 5 minutes, followed by heating to 300° C. and holding at 300° C. for 10 minutes. The surface treatment of the enameled substrate before spraying with sol-gel was varied as detailed in Table 3, below

TABLE 3

| | Surface | | | |
|---|---|---|---|---|
| | treatment | | | |
| | with | | | |
| Enamel | Blast | Adhesion | FIG. | Gloss % |
| Gloss Black | Yes | Best | 1 | 13.93 |
| Gloss Black | No | Good | 2 | 10.93 |
| Matte Black | Yes | Best | 3 | 8.40 |
| Matte Black | No | Better | 4 | 2.02 |

As illustrated in Table 3, the adhesion quality of the various layers of the coated substrates described above were evaluated. The quality of adhesion improved significantly when an enamel layer was roughened prior to contacting with a sol-gel material.

Also of note is that the gloss of the final non-stick coating layer was significantly higher when the underlying enamel layer was glossy.

2. Dishwasher Exposure

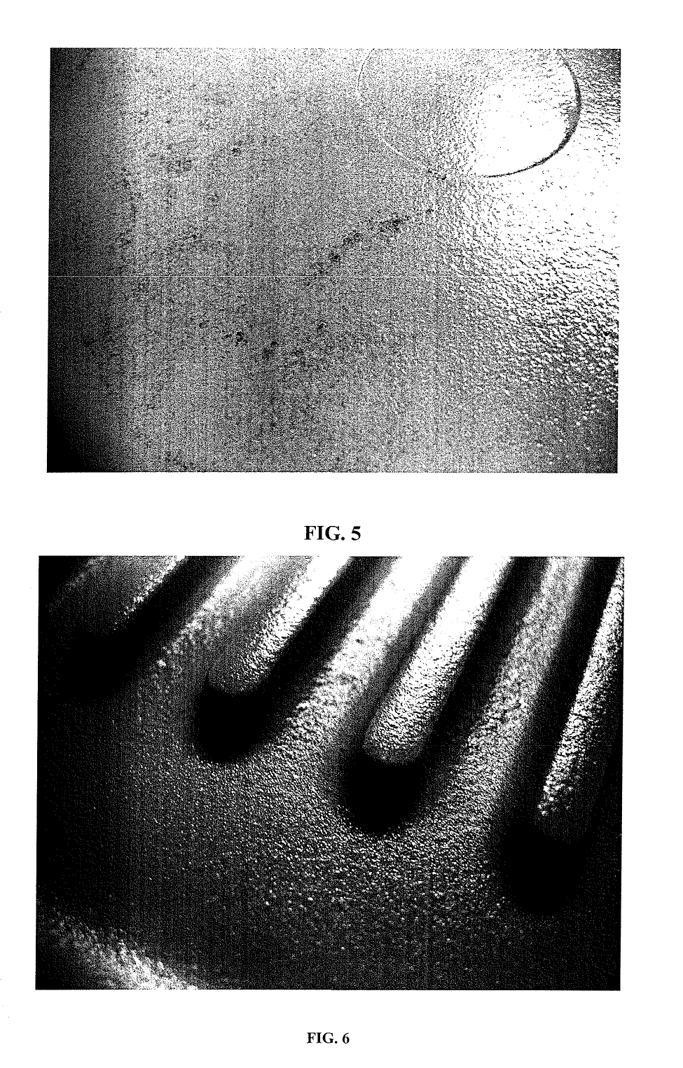

In a second example, cast iron substrates coated with the sol-gel compositions described herein were subjected to the environmental conditions of a dishwasher cleaning cycle. FIG. 5 illustrates a cast iron substrate coated with a sol-gel composition, but having no underlying porcelain enamel layer. After exposure to the dishwasher cycle, rust spots can easily be observed on the surface, indicating that the sol-gel composition is not effective on its own at prevent water and detergent from contacting the underlying substrate.

In contrast, FIG. 6 illustrates a cast iron substrate coated with a sol-gel composition, wherein an underlying porcelain enamel layer was present. After exposure to the dishwasher cycle, no rust spots were visible on the surface of the substrate, indicating that the combination of a roughened porcelain enamel coating and a sol-gel coating can be durable and can prevent water and/or detergent from contacting the underlying substrate.

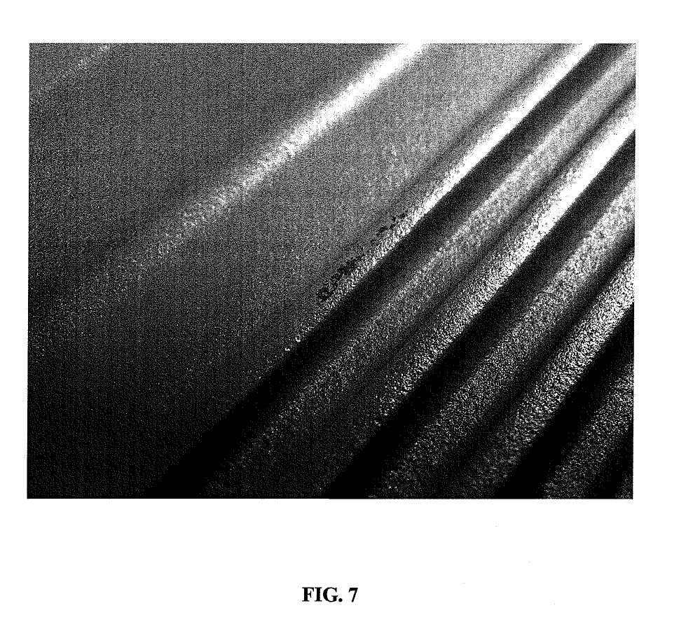

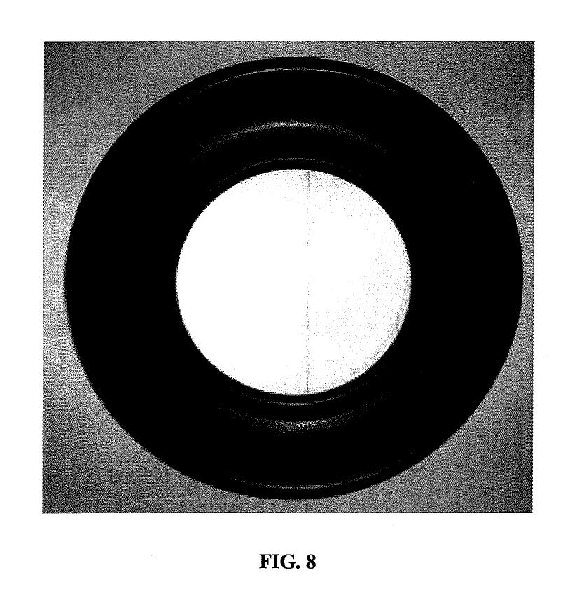

Similarly, FIG. 7 illustrates a cast iron substrate coated with a sol-gel composition, wherein an underlying porcelain enamel layer was present. Prior to exposure to the dishwasher cycle, the surface of the coated substrate was scratched, removing a portion of the non-stick sol-gel layer. After exposure to the dishwasher cycle, the scratch remained visible, but no rust spots were visible. This figure illustrates the durability and strength of the inventive combination porcelain enamel and sol-gel process described herein.

3. Spall Test

In another example, a coated substrate, such as a pan, can be heated until the interior temperature of the pan reaches 260° C. The pan can be held at that temperature for a period of about 10 minutes, at which time the pan can be quenched in ambient temperature tap water. This process can be repeated, for example, about 10 times, examining the coated substrate for changes in appearance or damage to the interior or exterior coating at the conclusion of each cycle. After each cycle, an egg can also be fried in the coated substrate to evaluate the non-stick properties thereof.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

4. Coating a Steel Burner Pan

In a fourth example, a low carbon steel burner bowl (ASTM A424-Type I) was coated with the steel enamel coating composition described in Table 2, above. The coated bowl was fired in a continuous furnace for a period of 18 minutes, where it was held at 826° C. for at least two minutes. After cooling, the enameled surface was roughened by blasting with 80 mesh silicon carbide grit at 5.1 bar to obtain a surface roughness of 2.5 micrometers. The roughened surface was heated to 30° C., and then sprayed with THERMALON® ROCKS. After spraying, the bowl was placed in a box furnace where the temperature was ramped from ambient to 280° C. in 12 minutes, and maintained at 280° C. for 10 minutes. The resulting part, depicted in FIG. 8, had a uniform non-stick finish.

5. Egg Test

In a fifth example, the ability of a non-stick skillet, prepared in accordance with this disclosure, to cook and release an egg was evaluated. The non-stick cast iron skillet was heated to 140° C. A raw egg was then cracked and its contents dropped on the skillet and heated for 2 minutes, with no oil, butter, or other fat applied to the skillet prior to or during cooking. Using a spatula the egg was then flipped and heated for another 2 minutes. The egg released with minimal resistance and with no residue left on the skillet, illustrating the non-stick and release properties of the various methods of the present disclosure.

6. Steak Sear Test

In a sixth example, the ability of a non-stick cast iron skillet, prepared in accordance with this disclosure, to sear and release a steak was evaluated. The porcelain and sol-gel coated non-stick cast iron skillet was heated to 280° C. and a 5 cm by 5 cm piece of steak was then positioned on the skillet and seared for 3 minutes. The piece of steak was then flipped and heated on the opposing side for 3 minutes. No oil, cooking spray, or other lubricant was applied to or added to the skillet prior to or during cooking. After the total 6 minutes of searing, the steak was removed from the skillet. Upon cooling, the skillet was easily wiped clean with a dry cloth, with no remaining residue. The skillet was subsequently reheated to 140° C., wherein an egg test, as described in Example 5, above, was performed. The cooked egg released easily with no remaining residue.

What is claimed is:

1. A method for coating a steel or cast iron substrate, the method comprising:
a) contacting at least a portion of a steel or cast iron substrate with a porcelain enamel coating formulation to form a first coating; and then
b) contacting at least a portion of the first coating with a sol-gel composition.

2. (canceled)

3. The method of claim 1, wherein at least a portion of the first coating has a surface roughness of from about 1.5 micrometers to about 3.0 micrometers.

4. The method of Claim 1, wherein the substrate comprises cast iron.

5. (canceled)

6. The method of claim 1, wherein the substrate comprises cast iron comprising at least one of:
a) a total carbon content from about 2.6 wt. % to about 4 wt. %;
b) a graphitic carbon content from about 2.4 wt. % to about 3.5 wt. %;
c) a combined carbon content from about 0.2 wt. % to about 0.52 wt. %;
d) a silicon content from about 2.1 wt. % to about 3.5 wt. %;
e) a manganese content from about 0.2 wt. % to about 1 wt. %;
f) a phosphorous content from about 0.1 wt. % to about 1.2 wt. %; or
g) a sulfur content less than about 0.09 wt. %.

7. The method of claim 1, wherein the substrate comprises steel.

8. (canceled)

9. The method of claim 1, wherein step a) comprises contacting at least a portion of a steel or cast iron substrate with a porcelain enamel coating formulation to form a single layer first coating.

10. The method of claim 1, wherein step a) comprises contacting at least a portion of a steel or cast iron substrate with one or more porcelain enamel coating formulations to form a multi-layer first coating.

11. (canceled)

12. The method of claim 1, wherein prior to step b), the substrate is heated to a temperature of at least about 732° C. for a period of time from about 8 minutes to about 12 minutes.

13. The method of claim 1, wherein prior to step b), the substrate is heated to a temperature of at least about 800° C. for a period of time from about 2 minutes to about 8 minutes.

14. (canceled)

15. The method of claim 1, wherein the sol-gel composition comprises a mineral based sol-gel material.

16. The method of claim 1, wherein the sol-gel composition is capable of forming a ceramic coating upon curing.

17. The method of claim 1, wherein the sol-gel composition comprises a silane containing material.

18. The method of claim 1, wherein the first coating has a gloss finish.

19. The method of claim 1, further comprising heating the substrate to a temperature of from about 20° C. to about 60° C. prior to step b).

20. The method of claim 1, further comprising after b), heating the substrate so as to cure the sol-gel composition and form a second coating.

21. The method of claim 20, wherein the second coating is substantially resistant to spalling, delamination, flaking, or a combination thereof.

22. (canceled)

23. The method of claim 20, wherein the second coating provides a non-stick or substantially non-stick surface.

24. The method of claim 20, wherein the first coating and the second coating do not comprise polytetrafluoroethylene.

25. The method of claim 20, wherein the first coating and the second coating do not comprise a fluorine containing organic polymer.

26. The method of Claim 20, wherein after step b), the substrate is heated at a rate from about 12° C./min to about 45°/min.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
